(19) United States
(12) Patent Application Publication
(10) Pub. No.: US 2010/0296105 A1
(43) Pub. Date: Nov. 25, 2010

(54) Method for Detecting Planar Deviations During the Unwinding of Flexible, Web-Type Flat Goods

(76) Inventors: Andreas Husner, Dresden (DE); Henry Drut, Dresden (DE); Tobias Nitsche, Dresden (DE)

Correspondence Address: JACOBSON HOLMAN PLLC, 400 SEVENTH STREET N.W., SUITE 600, WASHINGTON, DC, 20004, US

(21) Appl. No.: 12/225,429

(22) PCT Filed: Mar. 9, 2007
(86) PCT No.: PCT/DE2007/000478

§ 371 Date: Jul. 22, 2010

(30) Foreign Application Priority Data
Mar. 20, 2006 (DE) 10 2006 014 506.2

(51) Int. Cl. G01B 11/14

(52) U.S. Cl. 356/614

(57) ABSTRACT

The invention relates to a method for the detection of the planar deviations of flexible, web-type flat goods such as films of different materials which can also be used as packaging materials. It is the object of the invention to detect planar deviations directly on the rolling off of a flexible, web-type flat good from a roll in a contact free manner and with a low effort and/or cost. In accordance with the invention, in this connection, at least one ??? is present over at least one region of the width of the flat good on the rolling off with which the position and/or alignment of an imaged run-off edge can be determined with respect to a plane aligned parallel to the axis of rotation of the roll.

The invention relates to a method for the detection of the planar deviations of flexible, web-type flat goods such as films of different materials which can also be used as packaging materials. The flat goods are stored in wound form and are rolled off a roll for further processing or further treatment.

In so doing, planar deviations of a flat good occur due to thickness differences in the material. The irregular load on the flat good thereby caused on the winding up due to the winding tension can in particular result in the “flowing” of the flat good with viscoelastic materials, e.g. plastic films and soft aluminum films, when the time influence (storage of the wound up flat good) is taken into account.

Deviations from preset values can result in unwanted impairments subsequent to a rolling off of the flat good. For instance, problems in the further processing of the flat good can occur which at least cause down times of a corresponding plant installation.

If a flat good is used as packaging material, further losses occur in that the packed materials can as a rule no longer be used subsequent to damage.

It is therefore desired to be able to recognize such errors or defects. in good time in order at least to reduce resulting losses and time losses.

To tackle these problems it was proposed by 0. Becht and C. Hoelger in “Erfolgversprechende Methode zur Messung von Tragerverzug”; Papier and Folien; [A promising method for the measurement of carrier deformation″, Paper and Films]; 4th Edition, April 2003, p. 25-27 to determine a local deflection. Laser distance sensors are used in combination with air nozzles for this purpose. An airflow is directed onto a film at a specific pressure using the air nozzles. This solution is, however, complex and/or expensive in operation and also requires corresponding investment costs. In addition, the determination can only take place while taking a relatively high time constant into account since such a system is correspondingly sluggish. Furthermore, specific spacings between adjacent air nozzles and distance sensors must be observed so that the achievable spatial resolution is limited.

Optical measurement systems are known for applications of a somewhat different type.

It is thus proposed in WO 00/36402 A1 to use an optical distance measurement assembly at a paper making machine.

The solution described in DE 695 33 012 T2 relates to an optical monitoring in paper manufacturing in which the surface should be monitored using spatially fixed web sensors to be able to influence the quality of manufactured paper.

It is therefore the object of the invention to detect planar deviations directly on the rolling off of a flexible, web-type flat good from a roll in a contact free manner and with a low effort and/or cost.

This object is solved in accordance with the invention by a method having the features of claim 1. Advantageous embodiments and further developments of the invention can be achieved using features designated in the subordinate claims.

In accordance with the invention, a procedure is followed such that directly when the respective flat good is rolled off from a run-off edge, its position and/or alignment is/are determined using at least one optical detector with respect to a plane oriented parallel to the axis of rotation.

In this respect, the run-off edge is formed directly at the flat good being unwound from the roll at this moment and at the flat good still wound on the roll. With unwanted planar deviations, the position of the run-off edge, that is, the distance from a preset plane aligned parallel to the axis of rotation of the roll, can change. However, the alignment of the run-off edge can also change alone or additionally with respect to such a plane. The run-off edge can in this respect tilt at an obliquely inclined angle to this plane and can nevertheless extend in a straight line or can also extend in an arcuate curve, which can at least be the case in part at the run-off edge. A run-off edge can thus extend with concave or convex curvature. This can be the case over the total width of the flat good, but also only in a partial region (for example, at the center) or at the outer rims.

If the detected deviation of the position and/or of the alignment of the run-off edge exceeds a preset degree, this can be interpreted as an error in the flat good or as a winding error which has occurred on the winding up of the flat good onto the roll. In this case, the rolling off of the flat good from the roll can be stopped and greater damage can thereby be prevented.

It has surprisingly been found that the run-off edge can also be detected optically with a transparent flat good or a flat good reflective at the surface.

In the invention, the run-off edge can be detected over the total width of the flat good to be rolled off the roll. For this purpose, CCD lines, CCD arrays or video cameras can be used as example for optical detectors and can be arranged in accordance with their properties. An optical axis of a video camera can thus, for example, be aligned on the rolled off flat good at an obliquely inclined angle from above or from below and additionally parallel to the axis of rotation of the roll. It is thus advantageously possible to carry out a detection on a wide-format flat good with only one video camera.

CCD lines or also lines of a CCD array can be arranged parallel to the axis of rotation of the roll and additionally such that they can detect the region in which the run-off edge would be located without any planar deviation.

Optical detectors can be arranged orthogonally to the outer jacket surface of the flat good rolled off from the roll.

During the detection, the number of individual detection elements (e.g. the individual pixels of a video camera) can be determined at which a preset threshold value of a detected intensity has been reached, exceeded or fallen below. This is determined according to the type of optical detection. In this form, an alignment of the run-off edge which deviates from the preset value can preferably be recognized since at least one region of the run-off edge can be arranged outside a detection zone of the optical detector.

In this manner, or also in another suitable form, the portion of the detected run-off edge arranged inside a detection zone can be a measure for the evaluation. If, for example, 20% of the run-off edge is outside a detection zone, this can be a criterion for a required response.

Such a detection zone should be selected such that it is formed by two border lines arranged at a presettable distance from one another and aligned parallel to the axis of rotation of the roll. This can also be achieved virtually with a video camera as the optical detector.

An optical aperture slot can, however, also be arranged between the flat good and the optical detector for a defined detection zone. The slot can have a constant width over the total length of the aperture, that is, it can have a constant gap dimension.

On the arrangement of the detection zone, the successive change in the position of a run-off edge as a result of the reduction in the outer diameter occurring on the rolling off should be taken into account.

It can in particular be advantageous with a very wide flat good rolled off from the roll not to carry out the detection of the run-off edge completely and simultaneously, but rather sequentially. In this manner, only one region of the run-off edge can be detected simultaneously and subsequently another region of the run-off edge can be detected by switching over or realigning an optical detector. In each case, for example, an outer rim of the run-off edge can thus be detected alternatingly, whereas the middle region is taken into account rarely or at no point in time.

With a specific embodiment of flat good, however, due to its properties, a monitoring of the position or alignment of the run-off edge in a middle region of the flat good to be rolled off, that is, between outer rims, can be sufficient. This is in particular advantageous if such a flat good results in a curved extent of the run-off edge on a planar deviation.

In addition to the position and/or alignment of the run-off edge, a respective longitudinal deformation of the rolled off flat good can be determined in accordance with the invention while taking account of the respectively active web force, on the pulling off, of the modulus of elasticity of the flat good, of the instantaneous outer diameter of the roll with the flat good still wound up as well as of the distance to a subsequently arranged deflection roller. This can be taken into account, for example, on a subsequent printing of the flat good and such errors can be compensated in the arrangement of print images.

The position and/or alignment of a run-off edge can be detected directly using optical detectors. However, this can also be achieved with a projected optical image or a shadow of the run-off edge for some installations or types of flat good in that the projection or the shadow is optically detected.

It is directly possible with the invention, that is, also simultaneously with the rolling off of a flat good, to determine any planar deviation which may occur in a qualitative and a quantitative manner. It is thus possible to achieve a quality evaluation of a flat good or of the winding up of a flat good on a roll which is meaningful. In the ideal case, a run-off edge is aligned in a straight line and parallel to the axis of rotation of the roll.

The actual length relationships of the rolled off flat good occurring instantaneously can be determined with the invention. The determination takes place in a contactless, non-touching manner. Except for the web force, which is, however, required for the rolling off, no further force is exerted on the respective flat good.

The invention should be explained in more detail only by way of example in the following.

There are shown:

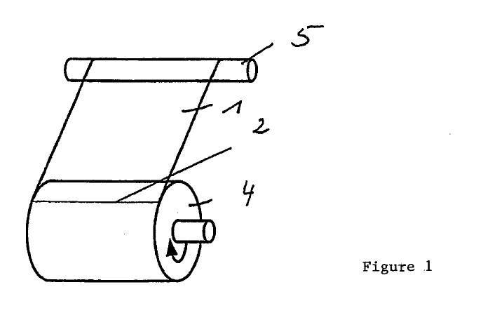

FIG. 1, in a schematic form, an ideally formed run-off edge at a flat good rolled off from a roll; and

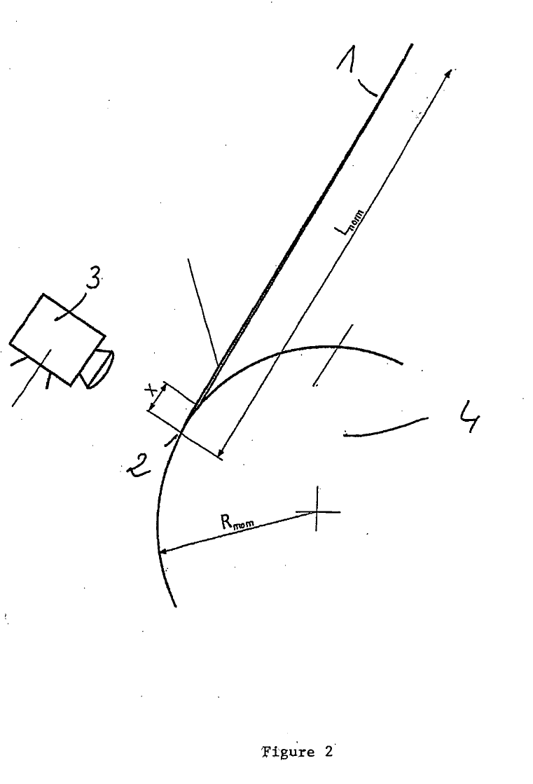

FIG. 2, in a schematic form, a possible arrangement for the determination of the planar deviation with a flat good rolled off from a roll.

It is shown in a schematic form in FIG. 1 how an ideal run-off edge 2, that is, a run-off edge aligned in a straight line and parallel to the axis of rotation of a roll 4 on the rolling off of a plastic film, can be made as a flat good 1 and how thus a state can be achieved on the rolling off of the roll 4 without any planar deviation of the flat good 1. The flat good 1 is transported on via a subsequently arranged deflection roll 5.

An ideal case or a state with a tolerable planar deviation and a state in which a non-tolerable planar deviation differing from a preset value has occurred and can be detected should likewise be illustrated in schematic form and viewed from a side in FIG. 2.

In this connection, a video camera, as an optical detector 3, is directed onto a surface region of the plastic film to be rolled off, as the flat good 1 at the outer diameter, for the detection of the position and/or alignment of the run-off edge. As can be recognized from FIG. 2, it can be arranged orthogonally to the outer jacket surface of the flat good 1 to be rolled off from the roll 4 and can be aligned thereto.

Two states are shown in this respect. In a state without any non-permitted planar deviation, the run-off edge 2 is arranged at a specific position and is formed with an alignment not deviating from the parallel.

In the second state, the position of the run-off edge 2 has moved and is arranged at a distance X from the preset position at Lₙₒᵣₘ while taking account of the normed outer diameter or radius Rₙₒᵣₘ. This space X can be determined and thus an undesired planar deviation can be recognized.

1. A method for the detection of planar deviations on the rolling off of flexible, web-type flat goods from a roll on which the flat good is stored in wound form, wherein the position and/or alignment of a formed run-off edge (2) is/are determined with respect to a plane aligned parallel to the axis of rotation of the roll (4) using at least one optical detector (3) over at least one region of the width of the flat good (1) on the rolling off.

2. A method in accordance with claim 1, characterized in that the position and/or alignment of the run-off edge (2) is/are determined simultaneously over the total width of the flat good (1).

3. A method in accordance with claim 1, characterized in that the position and/or alignment of the run-off edge (2) is/are determined using a CCD line, a CCD array or a video camera as an optical detector (3).

4. A method in accordance with claim 1, characterized in that the number of individual detection elements of the optical detector (3) which detect a presettable threshold value of a detected intensity is determined for the determination of the alignment of the run-off edge (2).

5. A method in accordance with claim 1, characterized in that the detection is carried out using one or more optical detectors (3) which is/are arranged orthogonally to the outer jacket surface of the flat good (1) rolled off from the roll (4).

6. A method in accordance with claim 1, characterized in that the determination is carried out within a detection zone having two border lines aligned at a presettable distance to one another and parallel to the axis of rotation.

7. A method in accordance with claim 1, characterized in that a presettable portion of the run-off edge (2) within the detection zone is detected using the optical detector (3) and is used as an evaluation criterion.

8. A method in accordance with claim 1, characterized in that the position of the detection zone is changed in dependence on the outer diameter with a wound on flat good (1) and is matched thereto.

9. A method in accordance with claim 1, characterized in that an optical slot diaphragm arranged between the run-off edge (2) and the optical detector (3) is used for the setting of the detection zone.

10. A method in accordance with claim 1, characterized in that the determination of the position and/or alignment of the run-off edge (2) is carried out sequentially over regions of the width of the rolled off flat good (1).

11. A method in accordance with claim 1, characterized in that a longitudinal distortion of the flat good (1) is determined while taking account of the acting web force, of the modulus of elasticity of the flat good, of the instantaneous outer diameter and of the distance from a subsequent deflection roll (5).

12. A method in accordance with claim 1, characterized in that the position and/or alignment of the run-off edge (2) is/are determined by means of a projected optical image or of the shadow of the run-off edge (2).
